(19) United States
(12) Patent Application Publication
(10) Pub. No.: US 2010/0007039 A1
(43) Pub. Date: Jan. 14, 2010

(54) METHOD FOR PRODUCING GRANULES FROM THERMOPLASTIC SILOXANE POLYMERS

(75) Inventors: Ernst Selbertinger, Burghausen (DE); Oliver Schaefer, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/722,206

(22) PCT Filed: Nov. 24, 2005
(86) PCT No.: PCT/EP2005/012584

§ 371 Date: Jun. 20, 2007

(30) Foreign Application Priority Data
Dec. 23, 2004 (DE) 10 2004 062 354.6

(51) Int. Cl. B29B 9/06

(52) U.S. Cl. 264/142

(57) ABSTRACT

Non-blocking polymer pellets are produced in spherical or nearly spherical form by introducing molten polymer directly from a polymerization reactor into a coolant and pelletizing just prior to, simultaneously with, or immediately following entry into the coolant such that residual heat allows the polymer pellets to change their shape to eliminate sharp corners, particularly cylindrical shapes, and assume a spherical-type morphology.

The invention relates to a process for production of pellets of thermoplastic siloxane polymers, in particular organopolysiloxane/polyurea/polyurethane block copolymers.

Preparation of thermoplastic siloxanes is described in I. Yilgör, Polymer, 1984 (25), 1800, and in EP-A-250248. The final reaction of the polymer units amounts to a comparatively simple polyaddition reaction, as used for preparation of polyurethanes. Starting materials used here as siloxane units for the siloxane-urea copolymers are bisaminoalkyl-terminated polysiloxanes. These form the soft segments in the copolymers, analogous to the polyethers in straight polyurethane systems. Familiar diisocyanates are used as hard segments, and these can also be modified via addition of diamines, e.g. 1,6-diaminohexane, or dihydroxy compounds, e.g. butanediol, to achieve higher strengths. The reaction of the bisamino compounds with isocyanates here takes place spontaneously and does not generally need any catalyst.

The silicone polymer units and isocyanate polymer units are miscible without difficulty over a wide range. Mechanical properties are determined via the ratio of the different polymer blocks: soft silicone segments and hard urea segments, and are substantially determined via the diisocyanate used. By virtue of the strong interactions of the hydrogen bonds between the urea units, these compounds have a defined softening point, and thermoplastic materials are obtained.

WO 96/34029 (corresponding to EP 822951 B1) gives a description here of the continuous extrusion of siloxane-urea block copolymers for production of release layers, and also gives a description of the use of these materials in extrusion applications. WO 96/34029 gives a description of the strand-pelletization treatment of the materials obtained via reactive extrusion, the aim here being to obtain polymer pellets. These pellets are known from other thermoplastics and permit conveying of solid materials in a manner similar to that of liquids, and they are therefore the basis of all stages of processing of thermoplastics. Production of pellets is therefore an essential precondition for the use of a material in injection-molding applications, since any injection-molding application involves a cyclic process, i.e. a batch process, unlike extrusion. The pellets here provide the connection between continuous production and batchwise processing. It is therefore usual to provide the connection between production and processing by way of continuous production of pellets or plastics pellets, which can then be processed either continuously or else batchwise. However, certain preconditions are needed for production and processing of plastics pellets. In continuous polymer preparation, only very small variations are permitted in the melt viscosity of the polymer, since these have a decisive effect on the thickness of the extruded strand and thus on the homogeneity of the polymer strand, and also its pelletization, since strands of varying thickness can lead to blocking of the pelletization equipment. Furthermore, the polymer pellets cannot be permitted to adhere to one another after pelletization, i.e. “blocking” of the material is to be prevented. For formation of a stable extruded polymer, a minimum melt viscosity is likewise desirable, since otherwise it is impossible to obtain self-supporting, stable polymer strands, the result being break-off of the polymer strand and thus interruption of the pelletization process. If a strand pelletizer is used, as sometimes used in WO 96/34029, the polymer formed is extruded in the form of a strand, and the extruded strand is then passed into a water bath, which cools a relatively long section under water. Then the strand is passed out of the water bath, freed from any adhering water, and then pelletized by a rotating knife or cutting rotor. Because the thermal conductivity of the siloxane polymer is poor, the residence time of the siloxane strand in the water bath has to be longer than with other thermoplastics, in order to achieve the necessary cooling. If the low thermal conductivity of the siloxane polymer leads to insufficient cooling extending to its core, the residual heat present causes end-to-end adhesion of the cylindrical pellets produced after pelletization in the strand pelletizer, and this leads to pellets which cannot then flow freely or be further processed. The same effect occurs when such pellets are stored in the type of warm environment prevailing in hot countries or in summer: because cylindrical (strand) pellets have smooth ends, the rate at which they cake and block tends to be greater than for spherical pellets.

Another disadvantage of cylindrical pellets is that their more angular geometry makes them less free-flowing than spherical pellets. This effect is even more marked with soft materials having low Shore hardnesses. However, good free-flow properties are absolutely necessary during further processing in conventional plastics-processing machinery, in order that metering gives a constant, uniform feed of pellets.

Another disadvantage of strand pelletization is strand pelletization of certain polymers having properties tailored to their specific application sector requires very disadvantageous conditions or is impossible. This applies in particular to some siloxane-urea block copolymers. These specific copolymers are prepared via use of certain diisocyanates, e.g. tetramethyl-m-xylene diisocyanate. They have, inter alia, very low melt viscosity, making them ideal for injection molding of even very thin-walled filigree items.

These copolymers also have a very narrow melting range from about 160 to 170° C. and with it have extremely little processing-temperature latitude for conventional strand extrusion and conventional strand pelletization. Just below the melting point, the material suddenly solidifies, but above this it is a low-viscosity liquid. This makes production by the strand-pelletization process very difficult, since very precise extrusion temperatures have to be maintained in this process.

It was an object to provide a process for production of pellets of thermoplastic siloxane polymers, in particular of organopolysiloxane/polyurea/polyurethane block copolymers, which avoids the disadvantages described above. A further object was to provide a process for production of pellets of thermoplastic siloxane polymers, in particular of organopolysiloxane/polyurea/polyurethane block copolymers, which can give polymers with different melt viscosities in pelletized form, and which inhibits blocking of the polymer pellets.

The invention provides a process for production of pellets of thermoplastic siloxane polymers, in particular organopolysiloxane/polyurea/polyurethane block copolymers, via
(d) transportation of the thermoplastic siloxane polymer, in particular organopolysiloxane/polyurea/polyurethane block copolymer, into which if appropriate previously additional additives have been incorporated by mixing, from the reactor into a coolant whose temperature is from −20° C. to 60° C., and
(e) direct pelletization of the polymer in the coolant, simultaneously during, or immediately after, entry of the polymer into the coolant.

Pellets of thermoplastic siloxane polymers are preferably produced via
(a) introduction, into a reactor, of the reactants required for preparation of thermoplastic siloxane polymers,
(b) mixing of the reactants in the reactor,
(c) allowing the reactants to react to form a thermoplastic siloxane polymer,
(d) transportation of the polymer from the reactor into a coolant whose temperature is from −20° C. to 60° C., and
(e) direct pelletization of the polymer in the coolant, simultaneously during, or immediately after, entry of the polymer into the coolant.

Pellets of organopolysiloxane/polyurea/polyurethane block copolymers are preferably produced via
(a) introduction of the reactants required for preparation of thermoplastic siloxane polymers into a reactor, where the reactants encompass at least one polyisocyanate and at least one polyamine, where at least one polyamine is a polydiorganosiloxanediamine,
(b) mixing of the reactants in the reactor,
(c) allowing the reactants to react to form an organopolysiloxane/polyurea/polyurethane block copolymer,
(d) transportation of the polymer from the reactor into a coolant whose temperature is from −20° C. to 60° C., and
(e) direct pelletization of the polymer in the coolant, immediately after, entry of the polymer into the coolant.

The following steps preferably follow step (e) of the process:
(f) cooling of the pellets in the coolant
(g) separation of the pellets from the coolant, and
(h) drying of the pellets.

The polymer formed in the reactor preferably takes the form of a melt and is therefore transported in the form of a melt in step (d) of the process and pelletized from the melt in step (e) of the process.

The polymer is preferably extruded from the reactor into a coolant, pelletization of the polymer taking place in the coolant without the substantial formation of a strand.

Formation of a strand means here that the length of the strand is substantially greater than the thickness, i.e. the diameter, of the strand. “Without substantial formation of a strand” means here that the length of the strand is not substantially greater than its diameter.

The inventive process can be carried out continuously, semicontinuously, or batchwise. It is preferably carried out continuously. Steps (a) to (h) of the process are therefore preferably carried out continuously.

Preference is therefore given to a continuous process for production of pellets of thermoplastic siloxane polymers via
(d) continuous transportation of the thermoplastic siloxane polymer from the reactor into a coolant whose temperature is from −20° C. to 60° C., and
(e) continuous direct pelletization of the polymer in the coolant, simultaneously during, or immediately after, entry of the polymer into the coolant.

This is preferably followed by
(f) continuous cooling of the pellets in the coolant
(g) continuous separation of the pellets from the coolant, and
(h) continuous drying of the pellets.

An advantage of the continuous process here is not only that the pellets are continuously discharged and dried but also that the coolant is returned after isolation of the pellets, the coolant thus being circulated.

It is therefore preferable that, in the continuous process, in step (a) of the process, the reactants required for preparation of thermoplastic siloxane polymers are continuously introduced into a reactor.

A further advantage of the inventive process is that it gives spherical pellets or approximately spherical pellets, these having good free-flow properties.

The grain size of the pellets produced by the inventive process is preferably from 0.3 to 10 mm, with preference from 2 to 5 mm.

Examples of coolants are water, water/ice mixtures, mixtures composed of water and of added water-soluble inorganic and/or organic materials, e.g. sodium chloride, silica sol, alcohols, di- and triglycols, polyglycols, polyether glycols, polyvinyl alcohols, polyacrylates, polyphosphates.

The coolants can moreover be composed of pure inorganic and/or organic liquids in which the copolymer is sparingly soluble or insoluble, examples being silanes, AK oils, polyglycols, methanol.

The coolants can comprise additives which improve the properties of the pellets, examples being silica sol as free-flow aid and/or as filler.

The coolant is preferably water or a water/ice mixture.

The temperature of the coolant is preferably from 0° C. to 35° C.

Step (d) to (h) preferably involves what is known as underwater pelletization, in which the cooling process and the pelletization process proceed at the extruder die giving pellets of thermoplastic elastomers in a form which has excellent flowability, the pellets moreover being free from blocking by virtue of their spherical shape and remaining flowable even on prolonged storage in a warm environment, this method moreover also being capable of processing thermoplastic siloxane polymers with very low melt viscosity and with very low Shore hardnesses. A further advantage of the inventive process is that this type of pelletization does not need a stable strand, since the polymer melt here is chopped via a rotating knife immediately after discharge from the extruder die, while the knife simultaneously rotates in a water bath, and therefore the chopped polymer particle is immediately surrounded on all sides by coolant, i.e. can be particularly effectively cooled, thus inhibiting the continued existence on the pellets of areas which retain heat and are tacky.

Any separation of the pellets from the coolant can by way of example take place in centrifuges, in cyclones, or in sieves, and any drying of the pellets can by way of example take place in drying centrifuges, in aerated (vibratory) sieves or cyclones.

Examples of reactors in which the polyaddition reaction can take place are:
batch or continuous kneaders, preferably single- or twin-screw kneaders (extruders, BUSS kneaders, List kneaders, and the like),
and also dynamic batch mixers, e.g. rotor-stator mixers, blade kneaders and the like.

The temperature in the reactor should be sufficient for reaction between the reactants and sufficient for transportation of the polymer formed. The reactor temperature is therefore preferably from 60° C. to 240° C., with preference from 80° C. to 200° C.

Preferred organopolysiloxane/polyurea/polyurethane block copolymers are those containing units of the general formula (1)

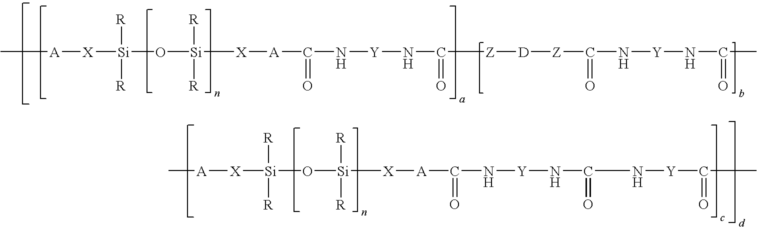

where
R is a monovalent, if appropriate fluorine- or chlorine-substituted hydrocarbon radical having from 1 to 20 carbon atoms,
X is an alkylene radical having from 1 to 20 carbon atoms, in which —O— groups can replace methylene units which are not mutually adjacent,
A is an oxygen atom or an amino group —NR′—,
Z is an oxygen atom or an amino group —NR′—,
R′ is hydrogen or an alkyl radical having from 1 to 10 carbon atoms,
Y is a divalent, if appropriate fluorine- or chlorine-substituted hydrocarbon radical having from 1 to 20 carbon atoms,
D is an if appropriate fluorine, chlorine-, C₁-C₆-alkyl-, or C₁-C₆-alkyl-ester-substituted alkylene radical having from 1 to 800 carbon atoms, in which —O—, —COO—, —OCO—, or —OCOO— groups can replace methylene units which are not mutually adjacent,
n is a number from 1 to 4000,
a is a number which is at least 1,
b is a number from 0 to 40,
c is a number from 0 to 30, and
d is a number greater than 0.

Organopolysiloxane/polyurea/polyurethane block copolymers and processes for their preparation are described in DE 10137855 A, DE 10313936 A, DE 10313938 A and DE 10326575 A, and DE 10137855 A, DE 10313936 A, DE 10313938 A and DE 10326575 A are therefore incorporated into the disclosure of the application.

R is preferably a monovalent hydrocarbon radical having from 1 to 6 carbon atoms, in particular unsubstituted. Particularly preferred radicals R are methyl, ethyl, vinyl, and phenyl.

X is preferably an alkylene radical having from 1 to 10 carbon atoms. The alkylene radical X is preferably uninterrupted. X is preferably a methylene radical or propylene radical.

A is preferably an NH group.

Z is preferably an oxygen atom or an NH group.

Y is preferably a hydrocarbon radical having from 3 to 13 carbon atoms, and is preferably unsubstituted.
Y is preferably an aralkylene radical or a linear or cyclic alkylene radical.

D is preferably an alkylene radical having at least 2, in particular at least 4, carbon atoms, and at most 12 carbon atoms.

It is likewise preferable that D is a polyoxyalkylene radical, in particular polyoxyethylene radical or polyoxypropylene radical having at least 20, in particular at least 100, carbon atoms, and at most 800, in particular at most 200, carbon atoms.

The radical D is preferably unsubstituted.

n is preferably a number which is at least 3, in particular at least 25, and preferably at most 800, in particular at most 400, particularly preferably at most 250.

a is preferably a number which is at most 50.

If b is not 0, b is preferably a number which is at most 50, in particular at most 25.

c is preferably a number which is at most 10, in particular at most 5.

d is preferably a number from 10 to 200, preferably from 30 to 100.

End groups which can occur in the organopolysiloxane/polyurea/polyurethane block copolymers can be conventional end groups of the prior art which are normally produced during the synthesis of these polymers, e.g. amino end groups or isocyanate end groups. These can then be reacted, during the synthesis or subsequently, with further groups, examples being amino- or isocyanatosilanes. The organopolysiloxane/polyurea/polyurethane block copolymers therefore preferably contain, as end groups B, a functional or non-functional organic or organosilicon radical. These end groups B are described by way of example in the abovementioned DE 10313936 A and DE 10326575 A.

A polydiorganosiloxanediamine used is preferably one of the general formula (2)

H₂N—X—[SiR₂O]ₙSiR₂—X—NH₂

where R, X, and n are defined as stated above.

In the copolymer of the general formula (1), it is preferable that at least 50 mol %, in particular at least 75 mol %, of urea groups are present, based on the entirety of the urethane groups and urea groups.

The polyisocyanate used is preferably a diisocyanate of the general formula (3)

OCN—Y—NCO

where Y is defined as stated above.

Examples of the diisocyanates to be used of the general formula (3) are aliphatic compounds, such as isophorone diisocyanate, hexamethylene 1,6-diisocyanate, tetra-methylene 1,4-diisocyanate, and methylenedicyclohexyl 4,4′-diisocyanate, or aromatic compounds, such as methylenediphenyl 4,4′-diisocyanate, toluene 2,4-diisocyanate, toluene 2,5-diisocyanate, toluene 2,6-diisocyanate, m-phenylene diisocyanate, p-phenylene diisocyanate, m-xylene diisocyanate, tetramethyl-m-xylene diisocyanate, or a mixture of these isocyanates. An example of commercially available compounds is provided by the diisocyanates of the Desmodur® line (H, I, M, T, W) from Bayer AG, Germany. Preference is given to aliphatic diisocyanates in which Y is an alkylene radical, since these give copolymers with improved UV resistance, this being advantageous when the polymers are used outdoors.

A marked improvement in the mechanical properties of the block copolymers can be achieved especially via use of chain extenders, such as diamino compounds, dihydroxy compounds, or water, in addition to the urea groups. This can give materials whose mechanical properties are entirely comparable with those of conventional silicone rubbers, but which have increased transparency, and which do not require incorporation of any additional active filler.

If b is at least 1, the second step can use up to 95% by weight, based on all of the components used, of chain extenders selected from the group of diamines, isocyanate-capped hydroxy compounds, dihydroxy compounds, and mixtures of these.

The chain extenders preferably have the general formula (4)

HZ-D-ZH

where D and Z are defined as stated above. If Z is O (oxygen), the chain extender (4) can also be reacted with diisocyanate (3) prior to reaction of the polydiorganosiloxanediamine (2) with diisocyanate (3).

The α,ω-OH-terminated alkylenes of the general formula (4) are preferably polyalkylenes or polyoxyalkylenes. These are preferably substantially free from contamination composed of polyoxyalkylenes of functionality other than two. It is possible here to use polyether polyols, polytetramethylenediols, polyester polyols, polycaprolactonediols, or else polyvinyl-acetate-based α,ω-OH-terminated polyalkylenes, or to use polyvinyl acetate-ethylene copolymers, polyvinyl chloride copolymer, or polyisobutyldiols. Polyoxyalkyl compounds are preferably used here, particular preference being given to polypropylene glycols. Compounds of this type are commercially available with molecular weights Mₙ up to more than 10 000 as starting materials inter alia for flexible polyurethane foams and for coating applications. Examples of these are BAYCOLL® polyether polyols and polyester polyols from Bayer AG, Germany, or Acclaim® polyether polyols from Lyondell Inc., USA. It is also possible to use monomeric α,ω-alkylenediols, such as ethylene glycol, propanediol, butanediol, or hexanediol. Other dihydroxy compounds for the purposes of the invention are bishydroxyalkylsilicones as marketed by way of example by Goldschmidt with the name Tegomer H—Si 2111, 2311, and 2711.

The water content of the copolymers of formula (1) prepared according to the present invention is preferably below 1% by weight and very particularly preferably below 0.5% by weight.

The copolymers described above of the general formula (1) can be prepared either in solution or else in solid form, continuously or batchwise. It is important here that ideal and homogeneous mixing of the constituents takes place for the selected polymer mixture under the reaction conditions and that phase incompatibility is, if appropriate, inhibited via solubilizers. Synthesis without solvents is preferred.

For the reaction without solvents, homogenization of the mixture is of decisive significance during the reaction. The polymerization can also be controlled via the selection of the reaction sequence in a synthesis involving stages.

To improve reproducibility, the preparation process preferably generally takes place with exclusion of moisture and under inert gas, usually nitrogen or argon.

The reaction preferably takes place, as is conventional for preparation of polyurethanes, via addition of catalyst. Suitable catalysts for the preparation process are dialkyltin compounds, such as dibutyltin dilaurate, dibutyltin diacetate, or tertiary amines, such as N,N-dimethylcyclohexaneamine, 2-dimethylaminoethanol, 4-dimethylaminopyridine.

The inventive process can actually also be utilized for incorporation of additional additives, e.g. color pigments, oils, plasticizers, fillers, e.g. thermally or electrically conductive fillers, with subsequent pelletization, giving pellets with even greater freedom from tack. The additional substances here are preferably incorporated prior to step (d) of the process after formation of the thermoplastic siloxane polymers.

The inventive pellets are preferably used in injection-molding applications, but they are equally suitable for any of the other thermoplastic applications (in the form of plastics additive) and processing methods (e.g. blown-film extrusion, extrusion of tubular product, film thermoforming).

Preferred applications of the copolymer pellets produced according to the present invention from the polydiorganosiloxane-urea copolymers of the general formula (1) are uses in the form of a constituent in adhesives and in sealants, in the form of starting material for thermoplastic elastomers, e.g. cable sheathing, hoses, gaskets, keypads, or for membranes (e.g. selectively gas-permeable membranes), or in the form of materials added to polymer blends, or for coating applications, e.g. in release coatings, tissue-compatible coatings, and flame-retardant coatings, and in the form of biocompatible materials. Other possible applications are sealants, polymer-processing additives, optical fibers, anti-fouling coatings, cosmetics, bodycare products, coatings additives, auxiliaries in laundry detergents and textile finishing, for the modification of resins or for the modification of bitumen. There are many possible uses of these thermoplastic materials: in sealants, in adhesives, for the producing and finishing of fibers, in the form of plastics additive (e.g. in the form of impact modifier or flame retardant), for improving the extrusion-and-blowing process when using metallocene-based polyolefins, in the form of material for antifoam formulations, in the form of high-performance polymer (in the form of high-transparency thermoplastic, high-transparency thermoplastic elastomer, elastomer), in the form of packaging material for electronic components, in insulation materials or in shielding materials, in cable sheathing, in anti-fouling materials, in the form of additive for products whose function is cleaning, cleansing, or polishing, in the form of additive for bodycare products, in the form of coating material for wood, paper, and cardboard, in the form of mold-release agent, in the form of biocompatible material in medical applications, for example in catheters, in adhesive plasters for wounds, in contact lenses, or in infusion hoses, in the form of coating material for textile fibers or textile fabrics, in the form of coating material for natural substances, e.g. leather and furs, in the form of material for membranes, and in the form of material for photoactive systems, e.g. for lithographic processes, optical data protection, or optical data transfer, in the form of additive for improving the mechanical properties of polymers, e.g. scratch resistance or ultimate tensile strengths, or in the form of extrusion auxiliary in the processing of thermoplastics.

Unless otherwise stated, all of the amounts and percentages in the examples below are based on weight and all of the pressures are 0.10 MPa (abs.). All of the viscosities were determined at 20° C. Molar masses were determined by means of GPC in toluene (0.5 ml/min) at 23° C. (column: PLgel Mixed C+PLgel 100 A, detector: RI ERC7515).

The average chain lengths of the α,ω-aminopropyl-terminated polydimethylsiloxanes used were determined by 1H NMR and Si29 NMR.

### EXAMPLE 1 (INVENTIVE)

The experiments were carried out using a ZSK 25 corotating 25 mm twin-screw kneader from Coperion Werner & Pfleiderer, Stuttgart, followed by underwater pelletizer from GALA, Xanten. The polyaddition reaction is carried out in the twin-screw kneader, and the hot polymer melt at 200° C. is continuously pelletized in the pelletizing unit of the underwater pelletizer, simultaneously cooled to coolant-water temperature, and then dried in the drying unit:

12 kg/h of α,ω-aminopropyl-terminated polydimethyl-siloxane whose average molar mass is 2700 g/mol and whose viscosity is about 50-100 mPa·s are metered continuously in the first heating zone of the twin-screw kneader. 0.99 kg/h of isophorone diisocyanate was metered in the second heating zone of the twin-screw kneader. The heating zones here were maintained at a temperature of from 130 to 190° C. The copolymer melt produced during reactive extrusion in the twin-screw kneader is conveyed continuously at a temperature of 190° C. into the underwater pelletizing unit. In this, the extruded melt was injected via a die (or via a plurality of mutually parallel circularly arranged dies), the diameter(s) of the die(s) being from 2 to 2.5 mm, into a pumped water-circulation system (water temperature 25° C.). On the water side of the die there was a knife head which rotated at high speed, cutting along the surface of the die and resulting in underwater pelletization of the melt strand at the die outlet, using 1600 rpm.

The melt droplets produced were pumped by the coolant-water circulation system into the drying unit. During transport, the pellet surface of the melt droplets cooled to about room temperature.

In the drying centrifuge, the pellets were centrifuged to remove water and passed to the receiver.

The water removed by centrifuging passed back into the water-circulation system.

This method gave almost spherical polymer pellets whose grain size was from 3 to 5 mm. The water content of the pellets after centrifugal drying was less than 0.1%.

The polymer pellets were then charged to a Plexiglass tube filled to a height of 100 cm and stored at 30° C. for 4 weeks. After this, the pellets were still completely flowable. It was possible to pour all of the pellets through a powder funnel with 2 cm funnel aperture.

### COMPARATIVE EXAMPLE 1 (NON-INVENTIVE)

For comparison, the copolymer was produced using a ZSK 25 corotating 25 mm twin-screw kneader from Coperion Werner & Pfleiderer, Stuttgart, with strand die, water bath, and strand pelletizer:

By analogy with Example 1, α,ω-aminopropyl-terminated polydimethylsiloxane whose viscosity was about 50-100 MPa·s was metered continuously in the first heating zone of the twin-screw kneader, and by analogy with Example 1 isophorone diisocyanate was metered into the second heating zone. The heating zones here were maintained at a temperature of from 130 to 190° C. The hot copolymer melt produced during reactive extrusion in the twin-screw kneader was passed by means of a double-aperture strand die into a water bath located below this at a temperature of 16° C. In this, the melt strand was passed under water, using deflector rollers, and cooled to the temperature of the water, then removed from the water bath and finally pelletized in a strand pelletizer from Rieter, Groβostheim.

This gave cylindrical strand-pelletized material, which was then charged to a Plexiglass tube using 100 cm fill height, where it was stored at 30° C. for 4 weeks. After this, complete blocking of the pellets had occurred. Only 27 parts by weight of the pellets could be poured through a powder funnel with 2 cm funnel aperture.

### EXAMPLE 2 (INVENTIVE)

The experiments were carried out using a ZSK 25 corotating 25 mm twin-screw kneader from Werner & Pfleiderer, Stuttgart, followed by underwater pelletizer from GALA, Xanten. The polyaddition reaction was carried out in the twin-screw kneader, and the hot polymer melt at 200° C. was continuously pelletized in the pelletizing unit of the underwater pelletizer, simultaneously cooled to coolant-water temperature, and then dried in the drying unit.

12.0 kg/h of α,ω-aminopropyl-terminated polydimethylsiloxane whose average molar mass is 2700 g/mol and whose viscosity is about 50-100 mPa·s were metered continuously in the first heating zone of the twin-screw kneader. 1.09 kg/h of 1,3-bis(1-isocyanato-1-methylethyl)benzene (TMXDI, tetramethyl-m-xylene diisocyanate) from Cytec Industries B.V., USA was metered in the second heating zone. The heating zones here were maintained at a temperature of from 150 to 200° C. The copolymer melt produced during reactive extrusion in the twin-screw kneader was conveyed continuously at a temperature of 200° C. into the underwater pelletizing unit. In this, the extruded melt was injected via a die (or via a plurality of mutually parallel circularly arranged dies), the diameter(s) of the die(s) being from 2 to 2.5 mm, into a pumped water-circulation system (water temperature 25° C.). On the water side of the die there was a knife head which rotated at high speed, cutting along the surface of the die and resulting in underwater pelletization of the melt strand at the die outlet, using 1600 rpm. The melt droplets produced were pumped with the coolant water-circulation system into the drying unit. During transport, the pellet surface of the melt droplets cooled to about room temperature.

In the drying centrifuge, the pellets were freed from water and passed to the receiver.

The water removed by centrifuging passed back into the water-circulation system.

This method gave spherical polymer pellets whose grain size was from 3 to 5 mm. The water content of the pellets after centrifugal drying was less than 0.1%.

The polymer pellets were then charged to a Plexiglass tube filled to a height of 100 cm and stored at 30° C. for 4 weeks. After this, the pellets were still completely flowable. It was possible to pour all of the pellets through a powder funnel with 2 cm funnel aperture.

### COMPARATIVE EXAMPLE 2 (NON-INVENTIVE)

For comparison, the copolymer was produced using a ZSK 25 corotating 25 mm twin-screw kneader from Werner & Pfleiderer, Stuttgart, with strand die, water bath, and strand pelletizer:

By analogy with Example 2, α,ω-aminopropyl-terminated polydimethylsiloxane whose viscosity was about 50-100 MPa·s was metered continuously into the first heating zone of the twin-screw kneader, and by analogy with Example 2, 1,3-bis(1-isocyanato-1-methylethyl)benzene (TMXDI, tetramethyl-m-xylene diisocyanate) from Cytec Industries B.V., USA was metered into the second heating zone. The heating zones here were maintained at a temperature of from 150 to 200° C. The intention was that the hot copolymer melt produced during reactive extrusion in the twin-screw kneader be passed by means of the strand die whose temperature was 160° C. into a water bath located below this using a temperature of 16° C., but it was impossible to produce a continuous melt strand, or the melt strand could not be introduced uniformly into the water bath, because, by virtue of the low melt viscosity of the melt, it ran immediately downward into the water bath at the strand die outlet, without forming a strand, or emerged very non-uniformly and relatively frequently broke away if melt viscosity was too low or too high. This method gave, after the water bath, either no product at all or just a few thin, non-uniform strands, which frequently broke away in the water bath and formed very non-uniform pellets. By virtue of the very inadequate strand formation, a very small yield of pellets was obtained, based on the amount of the raw materials used.

### EXAMPLE 3

The thermoplastic silicone elastomer pellets produced in Example 2 were blended with 2% by weight of carbon black from Degussa (Printex 60 A) and extruded at a temperature of from 180 to 200° C., using a ZSK 25 corotating 25 mm twin-screw kneader from Werner & Pfleiderer, Stuttgart. The copolymer melt produced during reactive extrusion in the twin-screw kneader was continuously conveyed into the underwater pelletizing unit, using a temperature of 200° C. In this, the extruded melt was injected via a die (or via a plurality of mutually parallel circularly arranged dies), the diameter(s) of the die(s) being from 2 to 2.5 mm, into a pumped water-circulation system (water temperature 25° C.). On the water side of the die there was a knife head which rotated at high speed, cutting along the surface of the die and resulting in underwater pelletization of the melt strand at the die outlet, using 1600 rpm. The melt droplets produced were pumped into the drying unit with the coolant water-circulation system. During transport, the surface of the melt droplets cooled to about room temperature.

In the drying centrifuge, the pellets were freed from water and passed to the receiver.

The water removed by centrifuging passed back into the water-circulation system.

This method gave black, spherical polymer pellets whose grain size was from 3 to 5 mm. The water content of the pellets after centrifugal drying was less than 0.1%.

The polymer pellets were then charged to a Plexiglass tube filled to a height of 100 cm and stored at 30° C. for 4 weeks. After this, the pellets were still completely flowable. It was possible to pour all of the pellets through a powder funnel with 2 cm funnel aperture.

1.-17. (canceled)

18. A process for production of pellets of thermoplastic siloxane polymers, comprising
(d) transporting thermoplastic siloxane polymer, into which additional additives have optionally been previously incorporated from a polymerization reactor into a coolant whose temperature is from −20° C. to 60° C., and
(e) directly pelletizing the polymer in the coolant, simultaneously during, or immediately after, entry of the polymer into the coolant.

19. The process of claim 18, wherein the pellets are spherical or substantially spherical.

20. The process of claim 18, comprising producing pellets of thermoplastic siloxane polymers by
(a) introducing into a reactor, reactants required for preparation of thermoplastic siloxane polymers,
(b) mixing the reactants in the reactor,
(c) allowing the reactants to react to form a thermoplastic siloxane polymer,
(d) transporting the polymer from the reactor into a coolant whose temperature is from −20° C. to 60° C., and
(e) directly pelletizing the polymer in the coolant, simultaneously during, or immediately after, entry of the polymer into the coolant.

21. The process of claim 18, comprising producing pellets of organopolysiloxane/polyurea/polyurethane block copolymers by:
(d) transporting organopolysiloxane/polyurea/polyurethane block copolymer, into which additional additives have optionally been previously incorporated, from a polymerization reactor into a coolant whose temperature is from −20° C. to 60° C., and
(e) directly pelletizing the polymer in the coolant, simultaneously during, or immediately after, entry of the polymer into the coolant.

22. The process of claim 21, comprising producing pellets of organopolysiloxane/polyurea/polyurethane block copolymers by:
(a) introducing reactants into a reactor, wherein the reactants comprise at least one polyisocyanate and at least one polyamine, and wherein at least one polyamine is a polydiorganosiloxanediamine,
(b) mixing the reactants in the reactor,
(c) reacting to form an organopolysiloxane/polyurea/polyurethane block copolymer,
(d) transporting the copolymer from the reactor into a coolant whose temperature is from −20° C. to 60° C., and
(e) directly pelletizing the copolymer in the coolant, simultaneously during, or immediately after, entry of the polymer into the coolant.

23. The process of claim 18, further comprising:
(d) extruding the polymer from the reactor into a coolant whose temperature is from −20° C. to 60° C., and
(e) without formation of a strand whose length substantially exceeds its diameter, pelletizing the polymer in the coolant.

24. The process of claim 18, wherein the following steps follow step (e) of the process:
(f) cooling the pellets in the coolant,
(g) separating the pellets from the coolant, and
(h) drying the pellets.

25. The process of claim 18, wherein the coolant is water or a water/ice mixture.

26. The process of claim 18, wherein the process is carried out continuously.

27. The process of claim 22, wherein the reactants comprise at least one polydiisocyanate and at least one polydiorganosiloxanediamine, and optionally one or more chain extenders selected from the group of the organic diamines and organic dihydroxy compounds.

28. The process of claim 21, wherein the organopolysiloxane/polyurea/polyurethane block copolymer comprises units of the formula (1) 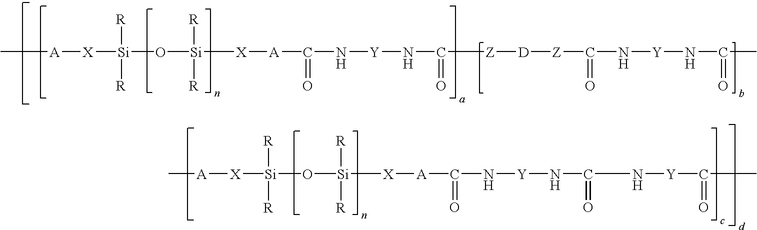
where
R is a monovalent, optionally fluorine- or chlorine-substituted C₁₋₂₀ hydrocarbon radical,
X is a C₁₋₂₀ alkylene radical in which —O— groups can replace non-adjacent methylene units,
A is an oxygen atom or an amino group —NR′—,
Z is an oxygen atom or an amino group —NR′—,
R′ is hydrogen or a C₁₋₁₀ alkyl radical,
Y is a divalent, optionally fluorine- or chlorine-substituted C₁₋₂₀ hydrocarbon radical,
D is an optionally fluorine, chlorine-, C₁-C₆-alkyl-, or C₁-C₆-alkyl-ester-substituted C₁₋₈₀₀ alkylene radical in which —O—, —COO—, —OCO—, or —OCOO— groups can replace non-adjacent methylene units,
n is a number from 1 to 4000,
a is a number which is at least 1,
b is a number from 0 to 40,
c is a number from 0 to 30, and
d is a number greater than 0.

29. The process of claim 22, wherein the polydiorganosiloxanediamine is one of the formula (2)
H₂N—X—[SiR₂O]ₙSiR₂—X—NH₂
where
R is a monovalent, optionally fluorine- or chlorine-substituted C₁₋₂₀ hydrocarbon radical,
X is a C₁₋₂₀ alkylene radical in which —O— groups can replace non-adjacent methylene units,
n is a number from 1 to 4000,

30. The process of claim 22, wherein the polyisocyanate is a diisocyanate of the formula (3)
OCN—Y—NCO
where
Y is a divalent, optionally fluorine- or chlorine-substituted C₁₋₂₀ hydrocarbon radical.

31. The process of claim 27, wherein a chain extender is one of the general formula (4)
HZ-D-ZH
where
D is an optionally fluorine, chlorine-, C₁-C₆-alkyl-, or C₁-C₆-alkyl-ester-substituted C₁₋₈₀₀ alkylene radical in which —O—, —COO—, —OCO—, or —OCOO— groups can replace non-adjacent methylene units,
Z is an oxygen atom or an amino group —NR′—.

32. The process of claim 28, wherein n is a whole number from 25 to 250, and R is a methyl radical.

33. The process of claim 28, wherein X is a methylene radical or propylene radical.

34. The process of claim 28, wherein Y is an aralkylene radical or a linear or cyclic alkylene radical.

35. The process of claim 18, wherein said polymer is introduced into the coolant below the surface of the coolant.

36. The process of claim 18, wherein the melt viscosity of the polymer, prior to its entry into the coolant, is too low to form a strand.
